(19) United States
(12) Patent Application Publication
(10) Pub. No.: US 2020/0297014 A1
(43) Pub. Date: Sep. 24, 2020

(54) FOOD AND BEVERAGE PASTE PREPARATION FROM NUTS, GRAINS, AND SEEDS

(71) Applicant: NUTTY MADE, INC., Miami, FL (US)

(72) Inventors: David Korstad, Miami Beach, FL (US); Hector Gutierrez, Miami Beach, FL (US); Jose A. Jimenez, II, Miami, FL (US); Isabelle Shu, Miami Beach, FL (US)

(21) Appl. No.: 16/551,821

(22) Filed: Aug. 27, 2019

Related U.S. Application Data
(60) Provisional application No. 62/820,297, filed on Mar. 19, 2019.

(51) Int. Cl. A23L 25/00; A23C 11/10; A21C 1/14

(52) U.S. Cl. CPC A23L 25/30; A23V 2002/00; A21C 1/1495; A23C 11/103

(57) ABSTRACT

A food and beverage paste preparation is formed by delivering a flour derived from nuts, seeds, grain or beans into a shear mixer. The flour may have a mean particle size between about 0.002 and 0.012 inches and a moisture content between about 4 to about 6 percent. The flour is sheared without adding water for mixing to form a food and beverage paste. The temperature during shearing does not exceed 120 degrees Fahrenheit and the food and beverage paste after shearing has a mean particle size of about 1 to about 40 microns.

### PRIORITY APPLICATION

This application is based upon U.S. provisional application Ser. No. 62/820,297 filed Mar. 19, 2019, the disclosure which is hereby incorporated by reference in its entirety.

### FIELD OF THE INVENTION

The present invention relates to the field of food and beverage preparations, and more particularly, this invention relates to forming a paste preparation from nuts, seeds, grain, or beans for food and beverages.

### BACKGROUND OF THE INVENTION

For a variety of reasons such as health, allergy, beliefs and religion, some individuals do not desire to consume dairy-based milk and similar dairy-based products or other similar dairy-based substitutes. For example, some individuals have an allergy to lactose that is typically found in dairy-based products. To address the desire for persons to consume a product having a taste and/or texture that is similar to a dairy-based milk, a variety of milk substitutes have been developed. Examples of materials from which milk substitutes have been prepared include oats and almonds. While certain features of these milk substitutes are adequate, many milk substitutes exhibit at least one feature that make it a less than optimal milk substitute.

Some of these milk substitutes include water, emulsifiers, and a nut substitute, such as an almond nut butter that is added to beverages and desserts as disclosed in U.S. Pat. Nos. 4,639,374 and 6,153,247; and U.S. Patent Publication No. 2016/0338389. The products disclosed in these references have some drawbacks. The almond nut butter for use in the beverage or dessert as disclosed in the '374 patent is produced from a roasted nut and may give a poor flavor, and according to its disclosure, may require surfactants, which may impart poor taste and change desired end-use characteristics. The product disclosed in the '976 patent incorporates a nut-based beverage concentrate and at least two or more essential ingredients, such as a potassium or sodium citrate, non-hydroxylated soy lecithin and carrageenan gum. These added ingredients add cost, make processing challenging in certain cases, and are not desired in many end-use applications.

The product disclosed in the '389 published patent application requires higher temperatures in processing, at about 180° F. in some examples, and requires adding water or oil during processing. This may create a poor production yield per hour, and although it may help form a nut butter, this nut butter characteristic is not always desired.

Another process is disclosed in the article by Aiello et al. entitled, “Controlled Temperature Grinding Under Modified Atmosphere For Almond (Prunus Dulcis) Paste Production,” which discloses a grinding process that includes use of a ball mill after a cutter mill. The process may form a butter, but it may not be beneficial at higher production rates desired in commercial production to form a nut “base” or “paste.”

There may be other drawbacks in these known processes. For example, the process disclosed in the '389 publication may reach temperatures closer to 180° F. This higher processing temperature may be problematic when processing certain nut based products, which can get close to roasting temperature, and be detrimental when trying to form a nut base or nut paste preparation. That '389 application process is also directed to a beverage that is not readily applicable to processing seeds, beans and legumes, or grains to form a paste or base. After grinding the nuts, the resulting butter is subject to a pasteurization treatment, which in itself as a process could create problems with oil retention and roasting. The process reduces particle size only partially to a small particle size, i.e., only to a larger micron size of about 0.003 inches, corresponding to 75 microns. This process disclosed in the '389 publication requires yet further processing even after grinding to about 75 microns in order to reach a stage for commercialization. These grinding machines are not always efficient, and there is limited disclosure of any beneficial use as a food or drink recipe replacement. Also because of the increased temperature during processing and the resulting heat generation, the nut product, similar to a butter, becomes very hot and according to its teaching, should be cooled immediately after manufacture, lessening any chance of some roasting. Another drawback is the use of one type of grinder that are sequentially used, and during the nut processing, adding water, which is not desirable in many cases.

The process disclosed in the '976 patent also requires adding water during processing to form a nut butter, in an example, a roasted nut butter having a moisture level below 4.0%, thus indicating a roasted product. Dry roasting and oil roasting may occur, which is not desirable and also the process dictates adding various essential ingredients. Aiello also requires its use of a ball mill, which is not conducive to forming a good nut paste preparation or similar paste preparation.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A method of forming a food and beverage paste preparation may include delivering a flour derived from nuts, seeds, grain or beans into a shear mixer. The flour may have a mean particle size between about 0.002 and 0.012 inches and a moisture content between about 4 to about 6 percent. The method includes shearing the flour within the shear mixer without adding water for shearing to form a food and beverage paste, wherein the temperature during shearing does not exceed 120 degrees Fahrenheit and the food and beverage paste after shearing has a mean particle size of about 1 to about 40 microns.

In an example, vacuum may be drawn within the shear mixer from beneath the nut based flour during shearing. Oil may be added during shearing when the flour is derived from grains. The shear mixer may comprise a vacuum bowl cutter containing the flour and rotating at about 20 to 40 rpm. The vacuum bowl cutter may include a knife blade set and drive mechanism supporting the knife blade set that rotates the knife blade set at about 4,500 to 6,500 rpm when shear mixing of the flour. The flour may be added into the shear mixer at a rate of about 0.65 to 0.99 pounds of flour per liter of shear mixer capacity. The flour may be cooled during shearing by subjecting the flour to cooled carbon dioxide or nitrogen to maintain the temperature of the flour during shearing to below 100 degrees Fahrenheit.

In yet another example, the shear mixer may comprise a planetary mixer having shear elements operating in a planetary mixing motion at about 4 to about 120 rpm. A rectangular stirrer blade may be included, and spaced disperser blades that rotate at about 1,000 to about 5,000 rpm. The temperature during shearing may range from about 70 to about 110 degrees Fahrenheit. The flour may be cooled before shearing to below about 45 degrees Fahrenheit into a chilled or frozen state. The food and beverage paste after shearing may be homogenized within a shear mill having a muli-slot rotor and a multi-port stator that reduce the mean particle size to below about 5 microns. The food and beverage paste preparation may have a shelf life of about one year without added antioxidants.

The nuts may be selected from the group consisting of almonds, cashews, macadamia nuts, hazelnuts, pistachios, Brazil nuts, coconuts, peanuts, pine nuts, walnuts, pecans, pili nuts, chestnuts, and breadnuts. The seeds may be selected from the group consisting of sunflower seeds, pumpkin seeds, hemp seeds, sesame seeds, watermelon seeds, cumin seeds, flax seeds, and chia seeds. The grains may be selected from the group consisting of oats, rice, quinoa, triticale, wheat, barley, spelt, and millet. The beans may be selected from the group consisting of coffee, cocoa, garbanzo, and kidney.

A system of forming a food and beverage paste preparation may comprise a cutting mill that receives nuts, seeds, grain or beans and cuts the nuts, seeds, grains or beans into a flour. The flour may have a mean particle size between about 0.002 and 0.012 inches and a moisture content between about 4 to about 6 percent. A shear mixer may receive and shear the flour without adding water for shearing to form a food and beverage paste. The temperature during shearing does not exceed 120 degrees Fahrenheit and the food and beverage paste after shearing has a mean particle size of about 1 to about 40 microns.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a flowchart of an example method for preparing the nut paste preparation in accordance with a non-limiting example.

FIG. 2 is a flowchart for preparing a beverage or food product from the nut paste preparation produced by the process of FIG. 1.

FIG. 3 is a flowchart showing greater details of the process of FIG. 1 for producing the nut paste preparation.

FIG. 4 is a schematic, front elevation view of an example shear mixer that may be used to produce the nut paste preparation from the process of FIGS. 1 and 3.

FIG. 5 is an enlarged view of an example knife blade set that may be used in the shear mixer of FIG. 4.

FIG. 6 is an enlarged front elevation view of a knife blade used in the knife blade set of FIG. 5.

FIG. 7 is a partial fragmentary and isometric view of another example of a shear mixer used to form the nut paste preparation.

FIG. 8 is a graph showing particle size distribution of the nut paste produced from the shear mixer shown in FIGS. 4 and 7.

FIG. 9 is a schematic view of an example homogenizer as a finishing shear mill that may be employed after the shear mixer.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

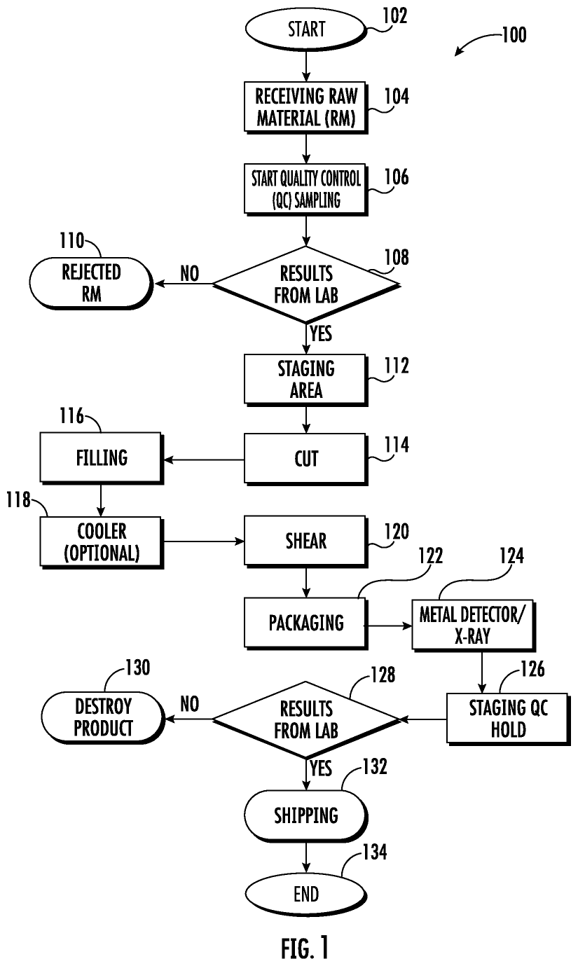

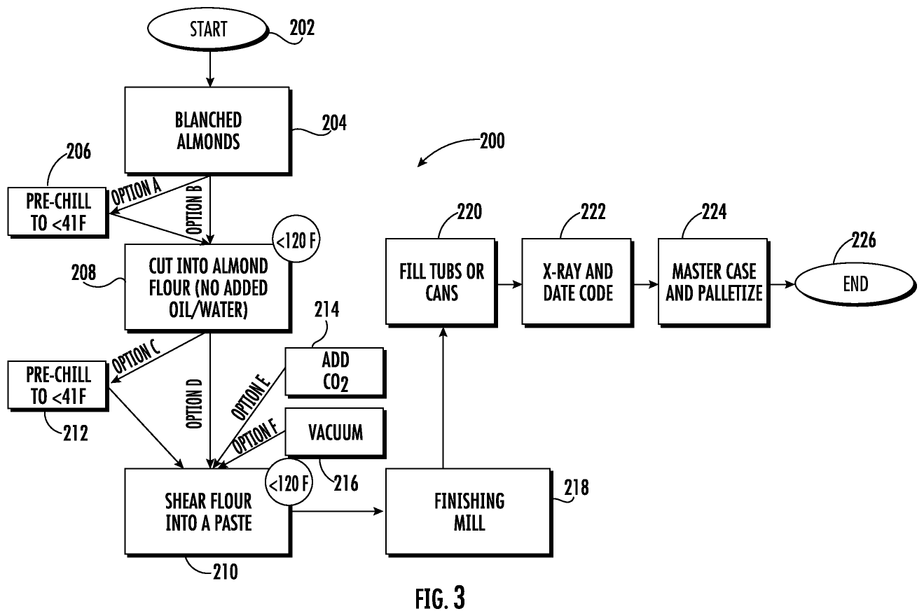

Referring now to FIGS. 1 and 3, there are illustrated flowcharts showing the process or method of forming the nut paste preparation for food and beverages, such as derived from almonds or other nuts, which is explained in greater detail below after discussing the characteristics of the nut paste preparation. It should be understood, however, that the process as described may be used to form a food and beverage paste preparation that is derived from nuts, seeds, grains or beans. An important aspect of the process is the use of a cutter in some examples, followed by a shear mixer as explained in greater detail below, which may be followed by homogenizing such as in a homogenizer mill, also referred to as a finishing shear mill, that receives a nut paste after shearing to reduce the mean particle size of the nut paste to below about 5 microns.

The system may process raw material, such as blanched almonds, in a cutting mill, which in an example, receives blanched, unroasted nuts and cuts the nuts into a nut based flour having a mean particle size between about 0.002 and 0.012 inches. This processing of nuts as a cutting step at this point occurs without adding water and oil for processing or cutting, and the temperature does not exceed 140° F. The shear mixer as explained in further detail below receives and shears this nut based flour without adding water and oil for shearing to form the nut paste. The temperature during shearing does not exceed 120° F. and the nut paste after shearing has a mean particle size of about 1 to about 40 microns. The shear mixing may be followed by homogenizing within a homogenizer, also known as a finishing shear mill, as explained further below to reduce the particle size to below about 5 microns as a mean particle size.

In an example, the shear mixer may include a vacuum system that draws a vacuum within the shear mixer from beneath the nut based flour during shearing. The temperature during shearing may range from about 70° F. to about 110° F. and it is possible that the nut base flour may be cooled before shearing to below about 45° F. into a chilled or frozen state. An example of the types of nuts that may be used as non-limiting examples include almonds, cashews, Macadamia nuts, hazelnuts, pistachios, Brazil nuts, coconuts, peanuts, pine nuts, walnuts, pecans, pili nuts, chestnuts, and breadnuts.

This nut paste preparation for food and beverages may be formed as a homogenized nut paste without added water or oil and have a mean particle size in the final product as a nut paste preparation, for example, of between about 1 to about 40 microns. The nut paste preparation is derived in this example from blanched, unroasted nuts, and has a moisture content of about 4.0 to 6.0 percent and water activity less than about 0.6.

The water activity A_{w} in this example may be considered the partial vapor pressure of water in a substance divided by the standard state partial vapor pressure of water, and in food science, most often defined as the partial vapor pressure of pure water at the same temperature. Thus, distilled water has a water activity of 1.0 and as temperature increases, the A_{W} increases. As is usually known by those skilled in the art, bacteria usually require a water activity of at least about 0.91 and fungi of at least about 0.7, and thus, the water activity less than about 0.6 for the nut paste preparation as described provides a product that without added antioxidants and produced by the processing as described below, will have an extended shelf life. In an example, the shelf life has been found to be at least about one year. In some cases, the shelf life has been found to be at least about a year and a half, without added antioxidants, and sometimes believed to extend up to about two years.

The process as described in greater detail below has been tested using almonds in an example. The nut paste flour from the cutting mill, in this example, is derived from blanched, unroasted nuts and further processed within the shear mixer without adding water or oil into a smooth, creamy nut paste preparation, also termed a “nut base” as a final preparation. In some examples, the process does not exceed temperatures of 100° F. as verified by some of the test results reproduced and explained below. The process is substantially different from some prior processes that do not create a paste, but instead produce a nut butter, and also require higher temperatures close to and sometimes above 180° F., thus resulting in roasting and harmful oil effects, and also requires the addition of oil or water during processing.

Some prior processes used standard equipment, for example, colloid mills or similar grinding mills to produce nut butters. These machines incorporated a standard machine technology in the nut butter industry, and often used grinding plates to apply an extreme amount of pressure to the almonds, nuts and other raw material products to break them down and release their oils. The grinding plates varied from course, medium, and fine, which determined the consistency of the final butter. These machines often reached very high processing temperatures, often over 190° F., to achieve a smooth butter consistency on a large scale production line. In other cases, the machines cannot be scaled and may not reach a high throughput.

The current process as described in greater detail below may be used on a mass scale of one thousand or greater pounds per hour with an uncooked/unroasted nut, such as from almonds with no oil or water added, and with a moisture content higher than 4%, and in an example, about 4-6%. Although almonds have been tested, as well as some cashews and oats using the process, it should be understood that different nuts may be used, as well as different seeds, such as sunflower seeds, pumpkin seeds, hemp seeds, sesame seeds, watermelon seeds, cumin seeds, flaxseeds, chia seeds, and other edible nuts and seeds. Grains may also be processed such as oat, rice, quinoa, triticale, wheat, barley, spelt, millet, and other edible grains. In some cases, it has been found that oil may be added during the shearing operation when the flour is derived from grains, although usually water and oil are not added, especially during the shearing with the shear mixer. Beans/legumes may be processed, including coffee, cocoa, garbanzo, kidney, and/or other edible beans.

The final food and beverage paste preparation as when raw materials are processed such as seeds, grains, and beans, and in an example, a nut paste preparation such as derived from almonds or other nuts, may be used as an ingredient to a recipe or added to other foods. For example, different drinks may have the food and beverage paste preparation added to a final drink product, including adding a nut paste preparation. These drinks include nut milks, seed milks, grain milks, bean milks, coffee, lattes, smoothies, tea, hot cocoa, milk shakes, and liquors. The food and beverage paste preparation may be added to different foods, including chia pudding, oatmeal, overnight oats, granola, soup, salad dressing, sauces, mashed potatoes, yogurt, cheese, butter, toast, pretzels, and cooking foods. Different snacks, treats, and desserts may include ice cream, butter cream/frosting, popsicles, frozen milk cubes, puppy chow, cheesy kale chips, pound cake, chocolate, snack bars, cookies, baked goods, tiramisu, and pastry filling in accordance with non-limiting examples.

Without added antioxidants, the food and beverage paste preparation, and in this example, the nut base preparation, has a low moisture content and low water activity and is typically processed without introducing water and oil, although when processing grains, oil may be added to help consistency because of the particular nature of the grains. For example, omega-3 and omega-6 oils are not added as compared to many other nut butter products. Those oils could have an impact on maintaining shelf-life. In an example, the nut paste preparation may have a free fatty acid concentration less than about 1.5% and the peroxide value may be less than about 5.0%. The color of the nut paste may be no darker than a flat sand color, and in an example, after homogenization, has been found to correspond to an RGB of about 210, 200, and 150 or a lighter tan color.

An aspect of the food and beverage paste preparation as a nut paste preparation is that the final product may not be a “butter” as described by the U.S. Department of Agriculture (USDA) guidelines, which refers to “grinding” to make nut butters, as compared to the cutting of blanched, unroasted nuts into a nut based flour, which is then sheared at low temperatures to form the current nut paste preparation. Butters are formed to be “spread” to have consistency in texture. According to the USDA, the nut butters, i.e., nut spreads as they are sometimes referred, should be spread easily and should not be more than slightly stiff. The food and beverage paste preparation, as an example nut paste preparation, on the other hand, is formed as a thick product and without using dehydrated almonds, nuts or other similar, raw incoming product. The incoming blanched almonds have a moisture content between about 5% to 6%, which with the cutting and shearing process and without high elevated temperatures, causes the preparation to be very thick. Thus, the nut paste preparation is similar to a wet cookie dough. It is stiff and does not spread easily as with the more common “butters.” For that reason, the nut paste preparation is not referred to as a butter herein. FDA labeling guidelines state that the common or usual name of the food, if the food has one, should be used as a statement of identity. If there is none, then an appropriate descriptive name, that is not misleading, should be used. Thus, the nut paste preparation is not referred to as a butter, but is referred to as a nut paste preparation, similar to a puree.

In an example, blanched California almonds were used to produce the nut paste preparation in a series of trials, and the final color of the nut paste preparation after processing had a no darker than flat sand color scheme, such as a tan color, and one example as noted before had a RGB as produced of 213, 194, 149, and CMYK of 0, 0.089, 0.300, and 0.164. The nut paste preparation had an almond flavor free from rancidity and any associated poor flavors or odors, and was smooth and creamy with no bits and no chunks. It was easy to scoop and was not a runny product similar to almond butter, and it was not hard similar to solid coconut butter. The particle size without a final homogenization was less than 75 microns as a mean particle size, and in an example, about 15 to about 40 microns, but after the homogenization in the finishing shear mill the mean particle size was less than about 5 microns. The nut paste preparation had a total aflatoxin of less than 15 PPB, a free fatty acid content of less than 1.5%, and a peroxide value less than 5.00%. A microbiological testing showed an aerobic plate count of less than 5000/cfu/g and coliform of less than 500/cfu/g. There were negative E. coli, negative salmonella and negative listeria. Yeast was less than 500/cfu/g and mold was less than 1000/cfu/g and negative Staphylococcus aureus.

Referring now to FIG. 1, there is illustrated a high-level flowchart of an example of a process for forming the food and beverage paste preparation, such as the tested nut paste preparation, which process is illustrated generally at 100. The process starts (Block 102), and raw material (RM) is received such as the unroasted almonds that had been blanched in this example (Block 104). Of course, other nuts, grains, seeds, and beans could be used and processing parameters will vary depending on the raw material. Quality control (QC) will sample the raw material (Block 106) and obtain results from a lab (Block 108). If the results are poor, the raw material is rejected (Block 110). If the raw material is acceptable, the raw material passes to a staging area (Block 112) and is then delivered to a cutting machine as will be described in greater detail below (Block 114), where the cutters will cut in this example the blanched, unroasted nuts into a nut based flour having a mean particle size between about 0.002 inches and 0.012 inches. These sizes may vary in certain cases, depending on raw material, by 5%, 10% or 15%. This processing occurs without adding water and oil and the temperature during this cutting does not exceed 140° F. The nut based flour may pass to filling machines where the filling machinery fills delivery containers (Block 116) with the nut paste flour, or it can pass directly to a shear mill. In an example, the nut based flour may be cooled (Block 118). Cooling is an optional step as described below.

At that point, the process continues with delivery of the nut based flour into a shearing mill where the nut based flour resulting from the cutting process is sheared (Block 120). No water or oil is added for shearing and the temperature remains below 120° F. The product at this point may be packaged or it may be further homogenized to reduce the particle size and then packaged (Block 122). The metal detector (Block 124) is used to detect any metal particle, and in an example, an x-ray may be used (Block 124). The nut paste preparation passes through a staging area for quality control, such as a holding bin (Block 126) and is tested. The results from the laboratory are analyzed (Block 128) and if the testing indicates a poor quality product, it may be destroyed (Block 130), but if the final nut paste preparation is acceptable, it may pass to shipping (Block 132) and finally the process ends (Block 134).

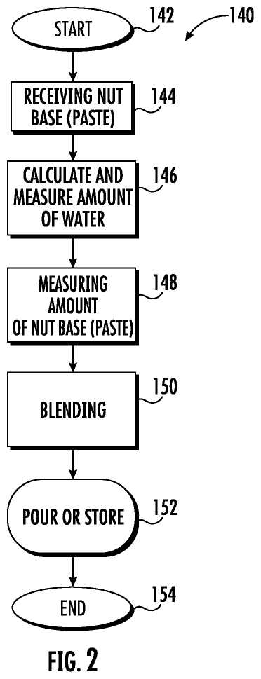

This final product could be shipped to another processor to add in bulk to large quantities of beverages or food, or even prepared for consumer purposes at point of sale locations. As shown in the process to prepare a food or beverage product during a commercial production operation as shown, for example, in the flowchart of FIG. 2, it is possible to prepare a beverage or food product from the nut paste preparation, e.g., the nut base using the process illustrated generally at 140. The process starts (Block 142) and the nut base or nut paste preparation as it is referred is received (Block 144). The amount of water is calculated and measured (Block 146) and the amount of nut base or paste is measured (Block 148). It is blended in an example (Block 150) and then poured or stored (Block 152) and the process ends (Block 154). This process 140 may be scaled to large or small commercial quantities.

Referring now to FIG. 3, there is illustrated another flowchart showing a method of forming a nut paste preparation for food and beverages and in this particular example, a nut base preparation from almonds and is illustrated generally at 200.

The process starts (Block 202) and blanched almonds are received (Block 204), which may optionally be pre-chilled to less than 41° F. as explained in greater detail below (Block 206), as a first option (A), or sent directly into the cutting mill as Option (B) (Block 208). The cutting mill receives in this example the blanched, unroasted nuts and cuts the nuts into the nut based flour having a mean particle size between about 0.002 and 0.012 inches. The cutting occurs without adding water and oil in this example and the temperature does not exceed 120° F. in this example.

At this point, the nut based flour is passed into a shear mixer that shears the nut based flour into a nut paste at a temperature of less than 120° F., and in this example, below 100° F. and the shearing may range from about 70° F. to about 110° F. (Block 210). Various options include pre-chilling to below 41° F. as option (C) (Block 212), going directly to the shear mill as option (D), adding CO₂ for cooling as option (E) (Block 214), and drawing vacuum within the shear mixer from beneath the nut based flour as option (F) (Block 216). The vacuum draw may operate in conjunction with cooling, whether by pre-chill cooling (Block 212) or the addition of CO₂ (Block 214). The quantities of CO₂ that are added may vary as explained below and may include adding dry ice. It is also possible to use nitrogen for cooling. In an example, CO₂ may be added in the form of pellets that are placed directly on the product, while a nitrogen cooling option may be an attachment on the machine that sprays the machine shell. If more CO₂ is needed to a batch being sheared, the machine is stopped, in one example, the lid opened, and more CO₂ pellets inserted. With nitrogen, more nitrogen is sprayed onto the shell of the bowl.

After shearing, the nut paste is passed into a finishing shear mill or homogenizing mill that homogenizes the nut paste after shearing and reduces the mean particle size of the nut paste to below about 5 microns (Block 218). Tubs or cans may be filled for packaging (Block 220). An x-ray may be conducted on the nut paste preparation to analyze the final product, and a date code then added (Block 222). The date code helps ensure customers know the expiration date based on shelf life. The final nut paste preparation is placed into a master case and palletized in a non-limiting example (Block 224). The process ends (Block 226).

In an example of processing nuts and almonds, the description has proceeded with describing blanched whole almonds that are shelled and the skin removed. Other blanched almonds may be used besides whole almonds, including blanched split almonds that are split in half, blanched sliced almonds that are sliced thinly lengthwise, or blanched slivered almonds that are split and then cut lengthwise. It is also possible to use diced blanched almonds that are cut into small pieces or blanched almond flour, where the blanched almonds had been ground into a fine powder or flour. Depending on the size and processing machinery used for blanching and the type of almonds or the type of nuts or other raw material products such as seeds, grains and beans, the raw material product after any blanching may be added directly to the shear mill without the first cutting in the cutting mill.

Examples of equipment and machinery that may be used for a blanching process include blanching machinery used for almonds and nuts and manufactured by Borrell USA. It is at this point that the pasteurization of the nuts or almonds occurs in the current process, where the temperature is above 180° F. and usually in blanching above 190° F. for at least two minutes and may extend up to 203° F. and higher in some processing examples. Blanching is a thermal process that removes the skins, i.e., almond skins in the case of processing almonds, and usually is a minimum process of two minutes or more of exposure to hot water at 190° F. or above, to provide a five-log or greater reduction of salmonella and other bacteria in and on almonds. The blanching process may include starting with the almonds in a holding tank and transferring by conveyor or elevator the almonds to a pre-wet tank or brine floater, followed by scalding in conjunction with a blancher roller chamber, with a possible skin aspirator and skin collector after processing within the blancher roller chamber. These steps may be followed by water rinsing on a table and transfer by conveyor or elevator into drying area where the loosened skin or pieces may be conveyed off. The process may continue with cooling and electronic sorting after transfer of the almonds into an electronic sorter. Scalding may be a continuous process and carried out in a circular tube in which hot water or steam-injected water is used to soak almond kernels that are directly exposed to hot water. Scalded almond kernels may pass through rubber rollers in a blanching chamber where loosened skins are removed.

A minimum time/temperature requirement for blanching is usually at least about 180° F. for hot water, and a four-log process requires almost three minutes, and in example, 2.47 minutes, and a five-log process requires at least about three minutes. Upper temperatures closer to about 190° F. may require only about 1½ minutes for a four-log process and about two minutes for a five-log process. Extended periods of time in blanching could cause roasting, oils to be removed, and/or a resulting poor taste for the end product as a nut paste preparation in this example. Moisture control is important and in an example, the blanched almonds have a moisture content of about 5%. In one tested example, the whole blanched almonds have about a 5.9% moisture content, a maximum adhering skin of about 2%, and about 2% discoloration.

It is also possible to process cashews that originate, for example, from Brazil or similar countries. Cashew kernels may have a moisture concentration of about a maximum 5%, and a peroxide value of about a maximum 5% before cutting, followed by shearing.

As noted before with reference to the flowcharts and process described in FIGS. 1 and 3, other raw material besides almonds may be derived from nuts, seeds, grain, or beans and is cut into a flour via a cutting machine, and in the case of almonds, as a nut based flour. The almond or nut based flour may have a mean particle size between about 0.002 and 0.012 inches. Cutting occurs without adding water and oil and the temperature during processing does not exceed 140° F., and preferably not exceeding 120° F. Example machines that may be used for this initial cutting before shearing include a Corenco Mill or Urschell Grinder.

It is possible to pre-chill the blanched almonds or other raw material to below 41° F. to maintain a cooler temperature before cutting to form a nut based flour or other flour based from the raw material. Especially for nuts, such as almonds, this pre-chill helps ensure temperatures do not rise to levels above 140° F. and especially above 180° F. and cause unwanted roasting. An example cutting machine is a Comitrol Processor Model 1700 produced by Urschell that includes three types of reduction heads for precise cutting. A product such as the almonds or other raw materials to be cut is guided into a high speed, rotating impeller. When the blanched almonds or other nuts or raw material as the product reaches the impeller, it may revolve at high speed inside a cutting head and the centrifugal force propels the product outward past the cutting edges of the stationary reduction head. Small portions of product projecting into the spaces between separators are cut-off into flakes by spaced columns of vertical knives and the flakes fly outward and away from the cutting head. Surfaces between the vertical knives are relieved to eliminate or reduce rubbing friction that would produce heat.

Although these types of machines manufactured by Corenco or Urschell have been found adequate for initial cutting to form the nut based four, these machines could not adequately produce the final nut paste preparation with the characteristics as desired, which required use of a shear mixer as described in greater detail below.

Testing had been accomplished using the cutting mill such as Comitrol Processor and Corenco Mill on almonds that were either refrigerated or frozen. It was found that processing in an attempt to form a desired end product as a nut paste preparation still produced excessive temperature during continued cutting, with the temperature ranging between 140° F. to 170° F. or higher. Sometimes the product would not break down properly and some temperatures reached as high as and over 170° F., such as with the Corenco Mill. It was determined at this point during testing of these two types of cutting machines that subsequent processing on different types of machines was required, and in this case, shearing was required such as using a Ross Turbo Mixer or Reiser Seydelmann Bowl Chopper. Other types of shear mixers may be used. In the process as developed, the shear mixer receives and shears the nut based flour from the cutting machine without adding water or oil to form a nut paste, and it has been found that the temperature during the shearing does not exceed 120° F. The nut paste after shearing in these machines had a mean particle size of about 15 to about 40 microns, and when homogenized in the homogenizer, below about 5 microns.

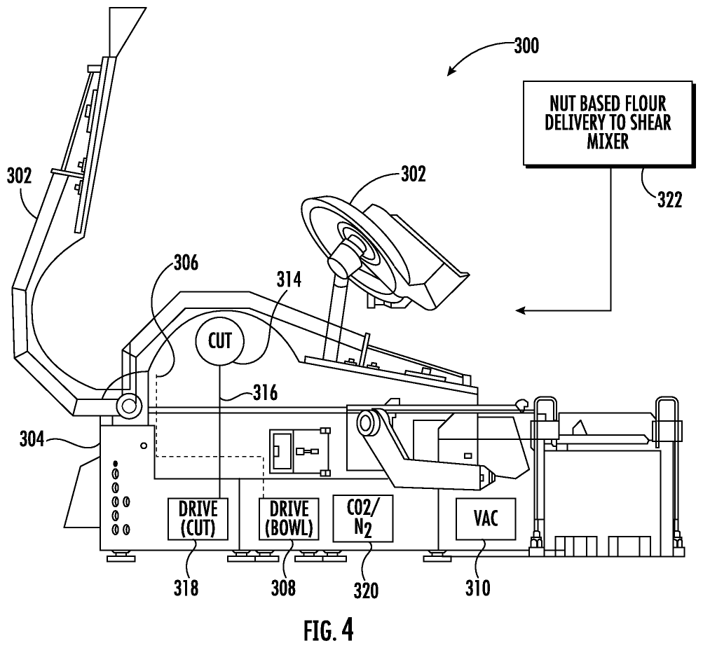

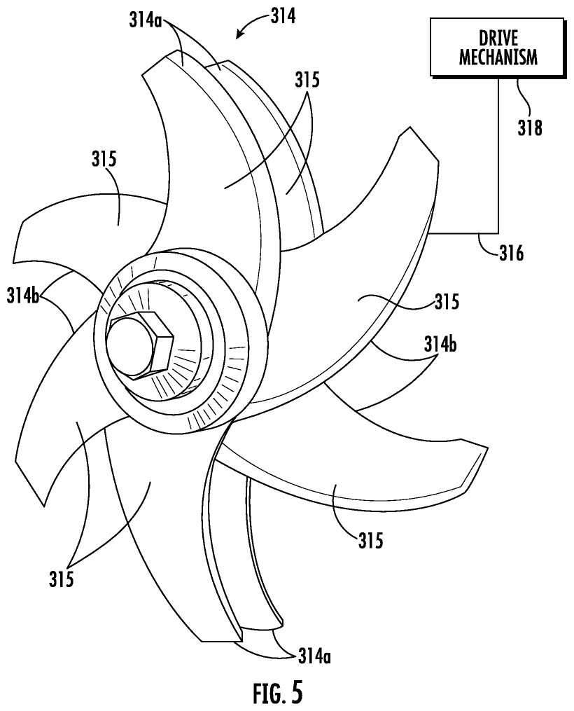

An example fragmentary and diagrammatic schematic drawing of a shear mixer that may be used in the current process is shown in FIG. 4 and in this example generally at 300 and shows basic components. This example of a shear mixer 300 is a Seydelmann Bowl Chopper manufactured by Reiser and includes lids or covers 302 that when closed form a tight seal with the housing 304. A bowl chopper as a vacuum bowl cutter 306 is shown diagrammatically by the dashed lines and connected to a drive 308 that operates to rotate the vacuum bowl cutter. The shear mixer 300 includes a vacuum system 310 that draws a vacuum within the shear mixer from beneath the nut based flour during shearing. The vacuum bowl cutter 306 is connected to drive mechanism 308, which rotates the bowl cutter at about 20 to about 40 rpm. The vacuum bowl cutter 306 may include a knife blade set shown schematically in FIG. 4 at 314, and is illustrated as an example in greater detail in FIG. 5, showing a knife blade set. In another example, the vacuum bowl cutter 306 may include first and second knife blade sets with separate drive shafts mounting each drive shaft. A drive shaft shown by the line 316 (FIG. 5) is connected to the knife blade set 314 that includes individual knives 315. A drive mechanism 318 connected to shaft 316 may drive the knife blade set 314 at about 4,500 to 6,500 rpm when shearing the nut based flour, in an example, 5,500 to 6,500 rpm. The knife blade set 314 includes opposing spaced blades 314a as four blades (FIG. 5) and adjacent blades 314b. The shear mixer 300 may also include a cooling source such as CO₂ or cooled nitrogen 320 and be delivered as CO₂ pellets or sprayed nitrogen on the bowl cutter 306 as non-limiting examples.

The nut based flour may be delivered via delivery mechanism 322 into the shear mixer 300 at a rate of about 0.65 is 0.99 pounds of nut based flour per liter of shear mixer capacity and this may be scaled to very large capacities. In another example, 0.7 to 0.99 has been found adequate. The nut based flour as delivered to the shear mixer 300 in one non-limiting example has a mean cut size as cut with the Urschell cutter of about 0.002 to 0.003 inches, with the largest cut size about 0.005 inches. The low and high cut sizes with the Corenco cutter may be determined by the disc size such as ranging from about 0.07 to 0.012 inches as a mean particle size.

Shearing occurs at low temperatures to achieve product quality. The temperature is maintained below 140° F. to maintain the integrity of the blanched almond color, flavor and nutrients, and preferably below 120° F. Using a Ross Turbo Mixer and a Reiser Seydelmann Bowl Chopper, it was found possible to maintain the temperature below about 100° F. using CO₂ or N₂ for cooling and vacuum together, for example. This lower temperature together with the shearing action from the various shear elements or blades permitted production of a high quality end product as a nut paste preparation. It is possible to cool or freeze the nut based flour before shearing, however. It was found that to use CO₂ or N₂ cooling with vacuum draw may form the better end product. At temperatures exceeding 180° F., the product begins to become roasted.

Use of the shear mixer 300 in processing allowed the production quantities to be increased and the almond breakdown to release the natural oils without adding high amounts of heat, while also achieving a high yield in pounds per hour production. The standard colloid mills, such as manufactured by IKA, or grinding machines having course, medium, fine and very fine grinding plates, such as an AC horn machine, have associated problems and lack product consistency since those machines process and add heat that exceeds 150° F. and even higher as demonstrated through testing, which ends up cooking the product. These types of machines do not provide a product that has a smooth and thick consistency. The shear mixer, on the other hand, such as the Reiser Seydelmann Bowl Chopper 300, uses a knife blade set 314 as described, and as the bowl 306 spins, the knife blades 314a, 314b have the product rotate through them, and do not require a paddle or other device for product bulk flow as compared to a Ross Turbo Mixer as will be described in greater detail below. The rotational domain of the planetary motion in a Ross Turbo Mixer as an example is translated into bowl rotation for the Reiser Seydelmann Bowl Chopper as the shear mixer 300, simplifying the mechanical solution and energy required.

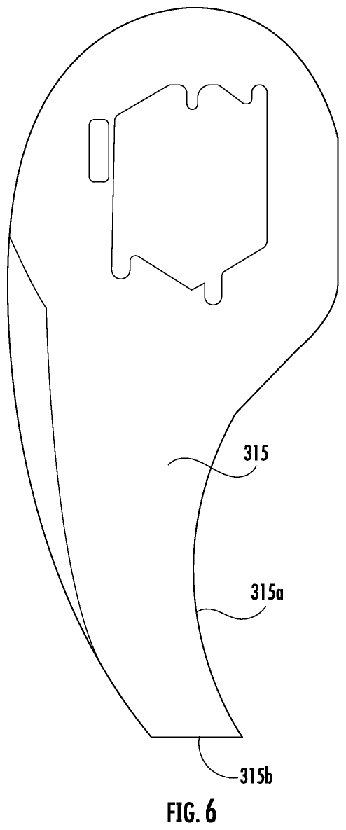

The shear mixer 300 may have chilled contact surfaces to control heat. For example, a series of tests were performed on a 60 liter Seydelmann Bowl Cutter. Different vacuum cutter models produced by Seydelmann and which can be scaled for use with the current process include K204, K324, K504, K604, K754, and K1004. An AC-8 motor had been recommended with one and cooling may also occur via the liquid nitrogen or a carbon dioxide delivery mechanism 320 to maintain the temperature of the nut based flour or other flour during shearing to below 100° F., in this example. It is possible to use a bi-cut K552 machine. The K/V blade has been found to work and an example knife blade set 314 is shown in FIG. 5 and an individual knife blade 315 is shown in FIG. 6. The knife blade 315 has a gentle, arcuate curve for the cutting edge 315a and the blade is used for high speed cutting. The cutting edge 315a terminates in a reduced width section having a straight cut 315b at the end. In an example, the knife blade set 314 rotated at about 6,000 rpm, and the bowl chopper 306 speed was about 27.6 rpm. The range is about 20 to 40 rpm for the bowl chopper 306 and about 4,500 to about 6,500 rpm for the knife set 314 when shearing. The range could be about 5,500 to 6,500 rpm, or about 5,000 to 6,500 rpm. These ratios should stay about the same when larger scale machines with greater capacity are used, but trial and error can properly validate, and in one example, 25 pounds was processed with no cooling and reached up to 50 pounds with cooling in a 60 liter bowl. It was found adequate in an example using a bowl chopper 306 to have about a range of 5,500 to 6,500 rpm. In yet another test of a different shear mixer, the blade/knife speed was about 4,700 rpm and a bowl speed of about 24. Product consistency was reached, but it added batch time and about 10% more 002 was needed.

Industrial bulk capacities for the shear mixer may range between about 40 liter and 1,200 liter. A yield in an example may be about 0.83 pounds per liter of capacity, but this can vary depending on the shear mixer and operating parameters. The shear mixer 300 as described is a closed machine when in operation with sealed lids 302, but may have a small opening to inspect and remove product if needed. The cooling option, such as CO₂, was used in an example trial for a batch size of 50 pounds in a 60 liter bowl that was mixed for 315 seconds. The temperature ranged from 71° F. to 90° F. and vacuum was used without a water spray. The amount of 002 as dry ice added during shearing was about 10% of the almond or nut based flour by weight and could range from about 5% to 15% and in another example, the amount of CO₂ added may range from about 10% to 40% by weight for safety. In another cooling option, almonds were first refrigerated and then processed in an example trial for shearing. A batch size of 50 pounds was used in a 60 liter bowl and mixed for 320 seconds. The temperature ranged from 47° F. to 140° F. and a vacuum system was used. A water spray can be used for cooling where the water is about 56° F. in an example and can be controlled to go colder. In that case, it may not be necessary to use CO₂ as cooling in this example. One trial reached the upper range of about 140° F. The various tables of the different experiments are set forth and the tables discussed below. In another experiment with other equipment, 200 pounds of whole almonds were placed in a 200 liter bowl chopper, but the processing worked better when it was reduced to 150 pounds and worked well. Thus, it is possible to have a 0.65 to 0.99 pounds to liter ratio.

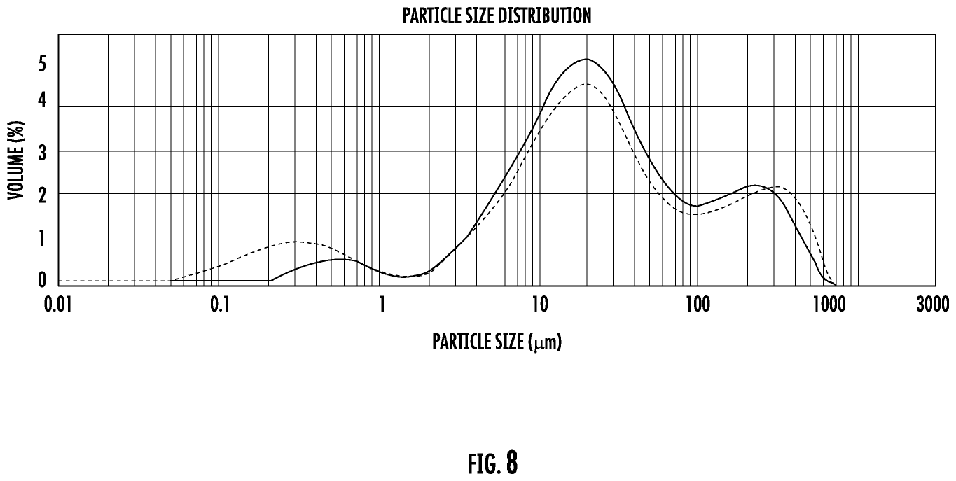

In another cooling option, nuts such as almonds were frozen before shearing. The batch size was about 50 pounds in a 60 liter bowl and mixed for 319 seconds. The temperature range of the product was about 23° F. to 140° F. and a vacuum system was used. A cooling water spray of about 56° F. could be controlled to go colder if needed. No CO₂ was used for cooling in this experiment. In another cooling option, it was possible to use liquid nitrogen but no testing occurred at this time with the liquid nitrogen. The particle size achieved with a Hegmann smear test was about 15 to 40 microns as shown in the graph of FIG. 8.

It is possible to add other ingredients at the beginning of shearing and have a batch creation at about initial processing timing at the beginning of shearing to allow enough time for the ingredients to be emulsified into the product. For example, if grains are used, oil may be added such as an oil or other syrup, including super food powders as tumeric, maca, matcha, beet root, maqui, acai, goji berry, cacao, charcoal, and other possible super food powders. It is also possible to add sweeteners, stabilizers, emulsifiers, and nutritional supplements such as vitamins and/or minerals. It is possible to add flavoring such as vanilla, chocolate, or cocoa and also add salt, colorants, antioxidants, bulking agents, and any other suitable ingredients and continue mixing until 100% finished.

Various test results using a Reiser Seydelmann shear mixer are now set forth below. Test results are shown and marked as Day 1 and Day 3. Using the vacuum shear mixer, air may be extracted during the shearing process. The avoidance of oxygen entry inhibits the propagation of microorganisms and reduces bacteria. The shelf life is found to be extended when vacuum is employed. Fat oxidation is avoided by removing atmospheric oxygen. Color is optimized and the chance of roasting is reduced. The density of the flour formed into the nut paste preparation is increased under vacuum and the smallest cell clusters may be captured by the knife set and sheared. The nut paste preparation becomes finer and more homogenous and free of foam. There is usually a small air space between the flour paste and underside of the cover in the Reiser machine to allow vacuum extraction in the shortest time and require a very low gas volume for re-gassing. Day 1 and Day 3 shear mixer test results, such as from the Reiser machine test results, are set forth below.

Day 1 Reiser Shear Mixer Test Results Summary

Batch 1—
50 lbs
60 L Seydelmann
K/V Blades
Blade RPM=6000
Bowl Speed=27.6
Hegmann Smear test=15-40 microns
Water Spray=none

| Time (secs) | Temp (degF.) | Dry Ice Added (lbs) |
|---|---|---|
| 0 | 71 | |
| 60 | 75.5 | |
| 90 | 81.1 | |
| 120 | 88.1 | |
| 150 | 99 | |
| 180 | 100 | 2.5 |
| 210 | 85 | |
| 240 | 89 | |
| 270 | 100 | 2.5 |
| 300 | 88.1 | |
| 315 | 90 | DONE - SAMPLE TAKEN |

Batch 2—
50 lbs
60 L Seydelmann
K/V Blades
Blade RPM=6000
Bowl Speed=27.6
Hegmann Smear test=15-40 microns
Single Sample after Finish

| Time (secs) | Temp (degF.) | Sample Taken |
|---|---|---|
| 0 | 47 (refrigerated) | |
| 30 | 60 | |
| 60 | 66 | |
| 90 | 70.2 | |
| 120 | 78.7 | |
| 150 | 89.5 | |
| 180 | 102 | |
| 210 | 110 | |
| 240 | 120 | SAMPLE TAKEN |
| 280 | 130 | SAMPLE TAKEN |
| 320 | 140 | SAMPLE TAKEN |

Batch 3—
50 lbs
60 L Seydelmann
K/V Blades
Blade RPM=6000
Bowl Speed=27.6
Hegmann Smear test=15-40 microns

| Time (secs) | Temp (degF.) | Sample Taken |
|---|---|---|
| 0 | 23 F. (frozen) | |
| 30 | 55 | |
| 60 | 64 | |
| 90 | 67 | |
| 120 | 72 | |
| 150 | 83.4 | |
| 180 | 95.5 | |
| 190 | 100 | |
| 214 | 110 | SAMPLE TAKEN |
| 240 | 120 | SAMPLE TAKEN |
| 273 | 130 | SAMPLE TAKEN |
| 319 | 140 | SAMPLE TAKEN |

Day 3 Reiser Shear Mixer Test Results Summary

Batch 1—
50 lbs
60 L Seydelmann
K/V Blades (but can also use high emulsion blades if desired)
Blade RPM=6000
Bowl Speed=27.6
Hegmann Smear test=15-40 microns
Water Spray=none

| Time (secs) | Temp (degF.) | Dry Ice Added (lbs) |
|---|---|---|
| 0 | 71 | |
| 60 | 75.5 | |
| 90 | 81.1 | |
| 120 | 88.1 | |
| 150 | 99 | |
| 180 | 100 | 2.5 |
| 210 | 85 | |
| 240 | 89 | |
| 270 | 100 | 2.5 |
| 300 | 88.1 | |
| 315 | 90 | DONE - SAMPLE TAKEN |

Batch 2—
50 lbs
60 L Seydelmann
K/V Blades (but can also use high emulsion blades if desired)
Blade RPM=6000
Bowl Speed=27.6
Hegmann Smear test=15-40 microns
Single Sample after Finish

| Time (secs) | Temp (degF.) | Sample Taken |
|---|---|---|
| 0 | 47 (refrigerated) | |
| 30 | 60 | |
| 60 | 66 | |
| 90 | 70.2 | |
| 120 | 78.7 | |
| 150 | 89.5 | |
| 180 | 102 | |
| 210 | 110 | |
| 240 | 120 | SAMPLE TAKEN |
| 280 | 130 | SAMPLE TAKEN |
| 320 | 140 | SAMPLE TAKEN |

Batch 3—
50 lbs
60 L Seydelmann
K/V Blades (but can also use high emulsion blades if desired)
Blade RPM=6000
Bowl Speed=27.6
Hegmann Smear test=15-40 microns

| Time (secs) | Temp (degF.) | Sample Taken |
|---|---|---|
| 0 | 23 F. (frozen) | |
| 30 | 55 | |
| 60 | 64 | |
| 90 | 67 | |
| 120 | 72 | |
| 150 | 83.4 | |
| 180 | 95.5 | |
| 190 | 100 | |
| 214 | 110 | SAMPLE TAKEN |
| 240 | 120 | SAMPLE TAKEN |
| 273 | 130 | SAMPLE TAKEN |
| 319 | 140 | SAMPLE TAKEN |

The results from the tests were a high quality nut paste preparation.

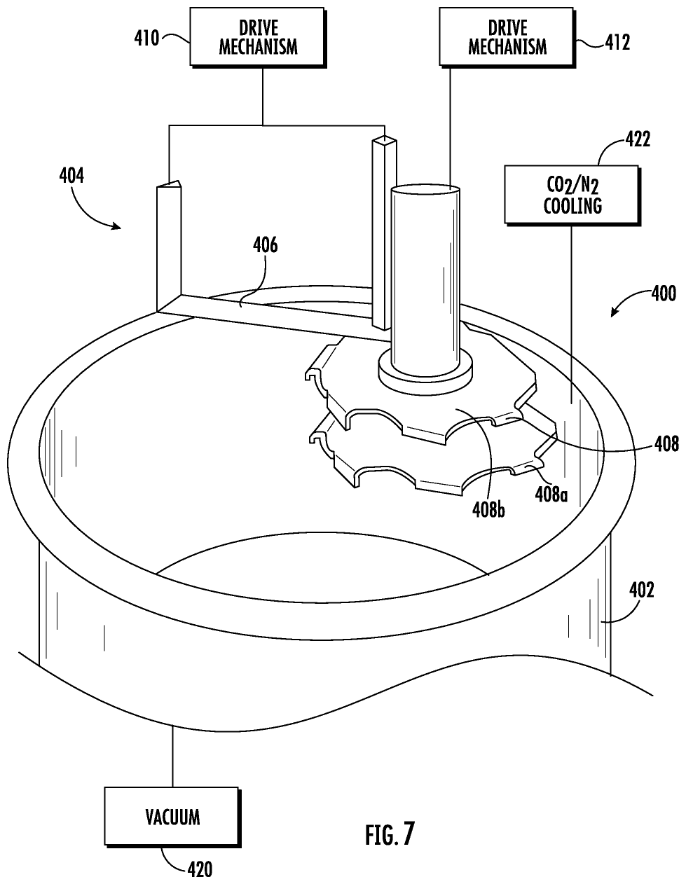

Besides the Reiser Seydelmann Bowl Chopper 300, it is possible to use a Ross Turbo Mixer, such as a double planetary mixer, that may have a full vacuum and air/oil hydraulic lift to lower and raise agitators to and from an operating position. These agitators include a rectangular stirrer and/or high viscosity (HV) disperser blades. It is possible to use a Ross PDDM that may have two rectangular stirrers or high viscosity (HV) blades and two high speed dispersers. An example of this type of shear mixer as manufactured by Ross is shown schematically at 400 in FIG. 7 and illustrates basic components of a planetary mixer having a receptacle or shear mixer bowl 402 and shear elements indicated generally at 404 and driven in a planetary mixing motion at about 4 to about 120 rpm. A rectangular stirrer blade 406 and spaced disperser shear blades 408 are included. The shear blades 408 rotate at about 1,000 to about 5,000 rpm. There may be a side wall scraper and bottom scraper not shown in detail. A drive mechanism 410 connects to the stirrer blade 406 and another drive mechanism 412 connects to the disperser shear blades 408 to drive and rotate them at proper speeds.

The disperser blades 408 operate as shear elements that may break up cells through mechanical energy by shearing and flinging the nut based flour in this example at a high rate of speed. The stirrer blade 406 operates as a paddle causing bulk movement. Vacuum drawn via a vacuum source 420 is an optional element that is desired in some examples to maintain the product at the lowest temperature without adding carbon dioxide or liquid nitrogen. A cooling mechanism 422, like the cooling mechanism 320 (FIG. 4), may use CO₂ or N₂.

A Power Mix Planetary Disperser (PDM 10) manufactured by Ross as a 10 gallon shear mixer was tested. It should be understood that other models with different specifications and model sizes can be used since the process allows for scaling. In one example, a rectangular stirrer and two six-inch high speed disperser blades with side wall and bottom scrapers were used. In another example, a three-inch blade with disperser blades closer together, such as three inches, was tested, but it did not break down the raw material fast enough. Two disperser blades that were wider apart were used to reach a scalable pounds per hour output. The blades impart a kneading action to the batch and smoothing consistency and break up agglomerates. In an example, the planetary mixing motion operated at about 38 rpm, but could range from 4 to 112 rpm and operate in a closed machine, and in this example, without CO₂ cooling.

As shown in FIG. 7, the blade configuration of the disperser blades 408 is much different in configuration than the blades 315 used in the shear mixer 300 described before. The shear mixer 400 includes blades and multiple cutting edges 408a extending 90 degrees down from a circular blade support 408b. Two blade supports 408b are supported on one drive shaft with the cutting edges on respective circular blade supports being staggered from each other.

In one batch size as tested with a Ross machine, 42 pounds of ground almond meal as the nut based flour was sheared in a 10 gallon mixer and mixed for 20 minutes. The batch size ratio can vary, but the ratio may stay the same with scaling up to larger sizes. Some trial and error may be used to validate scaling to larger scale sizes. Some testing was sufficient to run 42 pounds in a 10 gallon shear mixer with capacities between one-half and 750 gallons. For a maximum yield, the shear mixer 400 would be about 4.2 pounds per gallon of capacity in an example. A Power Mixer Ross shear mixer is available in sizes from one-half to 750 gallons and the planetary dual dispersers are available as 2.5 to 750 gallon sizes. A double planetary mixer is available in 2 to about 750 gallon sizes.

The temperature may range from about 70° F. to 110° F. and in some experiments, about 70° F. to about 96° F. The vacuum mechanism 420 was located to draw vacuum under the sheared material and vacuum was used 100% of the time. About 29 inches of Mercury (Hg) was applied as the standard atmospheric pressure for the vacuum and found beneficial. The particle size achieved with this shear mixer 400 was about 40 to about 50 microns and the measured viscosity using a Brookfield Viscometer was about 80,000 centipoise at 1 RPM and 46,000 centipoise at 5 RPM. Material was shear thinning before product viscosity decreased under shear strain.

Two primary shear elements may be used in a planetary or off-center motion for generating not only bulk flow in the shear mixer 400 but also provide high shear, in an example, using vacuum to accelerate any oiling off of the nut paste or almond flour. Manifestations of the bulk flow element could include a variety of custom scrapers, anchor style mixer blades, paddles, pins, ribbons, and other styles used in the trade that can be applied for shearing. There were different types of shear elements, such as a rotor-stator and high-speed rotor. Rotor-stators were not recommended because of the difficulty to clean in the application. High-speed rotors could include a common disperser plate, slotted dispensers such as an Admix roto solver and other systems known to those skilled in the art. The disperser plates were found to work well to generate shear in a powder system as well as a liquid.

Test results using a Ross shear mixer as described are set forth below.

Ross Shear Mixer Test Results Summary

Test 1—
6 lbs ground almond meal
Mix Model PDM2—6 gallon power mixer
Rectangular Stirrer+one 3″ high speed disperser blade with side wall and bottom scrapers
Vacuum turned on at minute 20 at 29 in Hg
Viscosity, Brookfield
   1 rpm=80000 centipoise
   5 rpm=46000 centipoise
   Material is shear thinning

| Time | Temp | | | | |
|---|---|---|---|---|---|
| (min) | (degF.) | Disperser Speed | Planetary Speed | | Vacuum |
| 0 | — | 1250 rpm | 28 | rpm | 0 |
| .25 | — | 5000 rpm | 28 | rpm | 0 |
| 0.5 | — | 5000 rpm | 56 | rpm | 0 |
| 15 | 96 | 5000 rpm | 56 | rpm | 0 |
| 20 | — | 5000 rpm | 56 | rpm | 29 in Hg |
| 22 | — | 5000 rpm | 112 | rpm | 29 in Hg |
| 23 | 95 | 5000 rpm | 112 | rpm | 29 in Hg |

Test 2—
42 lbs ground almond meal
Mix Model PDM10—10 gallon power mixer
Rectangular Stirrer+two 6″ high speed disperser blades placed about 6″ apart with side wall and bottom scrapers

| Time | Temp | | | |
|---|---|---|---|---|
| (min) | (degF.) | Disperser Speed | Planetary Speed | Vacuum |
| 0 | 70 | 2450 rpm | 38 rpm | 29 in Hg |
| 17 | 90 | 2450 rpm | 38 rpm | 29 in Hg |
| 20 | 96 | 2450 rpm | 38 rpm | 29 in Hg |

Test 3—
25 lbs whole blanched almonds
Mix Model PDM10—10 gallon power mixer
Rectangular Stirrer+two 6″ high speed disperser blade with side wall and bottom scrapers, placed about 3″ apart

| Time | Temp | | | | |
|---|---|---|---|---|---|
| (min) | (degF.) | Disperser Speed | Planetary Speed | | Vacuum |
| 0 | 70 | 2450 rpm | 4 | rpm | 29 in Hg |
| 3 | — | 2450 rpm | 38 | rpm | 29 in Hg |
| 30 | 88 | 2450 rpm | 38 | rpm | 29 in Hg |
| 40 | 94 | 2450 rpm | 38 | rpm | 29 in Hg |

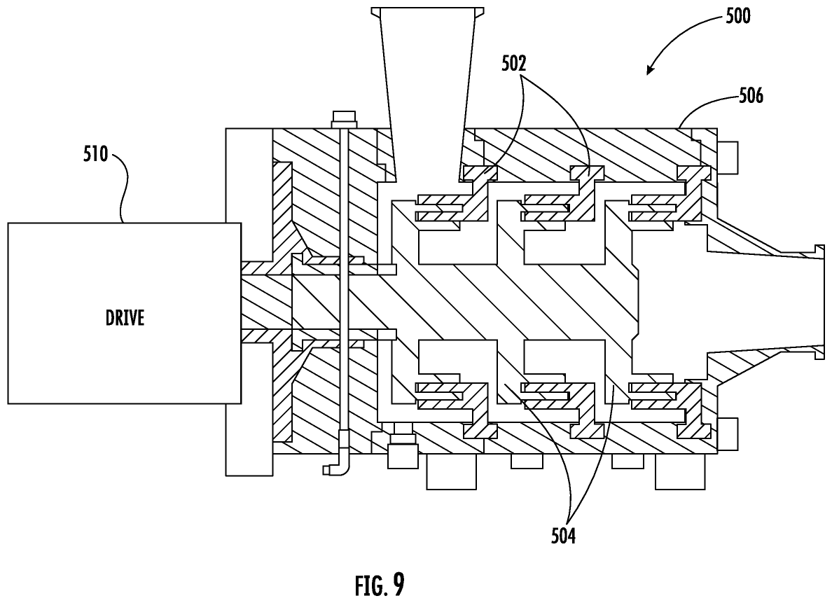

After shearing, the particle size distribution ranges from about 15 to about 40 microns as a mean particle size, shown in the graph of FIG. 8, showing the particle size in microns along the horizontal axis and the volume percent along the vertical axis. This product may be commercialized at this point, or it may be processed further, such as homogenized. To make a more homogenized and finer nut paste preparation, the nut paste (or paste derived from seeds, grains and beans) after shearing is homogenized within a finishing or homogenizer shear mill illustrated generally at 500 in FIG. 9, having a multi-slot rotor 502 and a multi-port stator 504 within a housing 506. The rotor 502 and stator 504 operate together via a drive motor 510 to reduce the mean particle size to below about 5 microns. An example finishing shear mill is an Admix Boston Shear Mill 25-3 and having back pressure apparatus such as a Model 18 Waukesha PD pump.

This type of in-line homogenizer and wet mill surpasses the capabilities of conventional shear pumps and colloid mills and provides very high throughputs at extreme shear rates. Different plates may be used with different settings, including fine, very fine, and ultra-fine heads with a pressurized system. The tip speed may range from about 100 to about 125 FPS and have a throughput in one example of about 5 to 15 GPM and upwards in some high capacity commercial applications from about 15 to 50 and sometimes 40 to 165 GPM. Rotor 502 and stator 504 ports may have wire-cut radii and a closed slot design in the rotor and stator to prevent twisting and bending. The multi-slot rotor 502 may turn at high speeds in close proximity to a multi-port stator 504 with each shear head having a rotor and stator and a double ring design in an example to provide three distinct, high-intensity work zones at each rotor/stator location where the mixture passes. These zones could include between the first set of rotor 502 slots or teeth and a first ring of slots on the stator 504, between the first ring of slots on the stator and a second ring of slots in the rotor, and between the second ring of slots in both the rotor and stator. In one experiment, the shear mixing worked well with an oat sample. Some temperatures increased and when the nut paste reached 120° F., it was transferred back to the hopper for the finishing shear mixer 500.

The bulk product as a nut paste preparation or other paste preparation may be held upstream from fillers, while staying emulsified after the shear mixing, and the nut paste preparation may be transferred from one vessel machine to the next. The filling process may use a basic piston filler as a Heinz-Bock filler that works with high viscosity material. Filling may include a front port 2P-160 tub filling line with two inch vertical blow-off spouts and the flow rate varies based off fill speed, fill volume, and pump design. There may be an Automatic Lidder that has capacity to lid pail containers. A date coder applies a date to the pails that correspond to the best buy dates and lot codes in the product packaging. An x-ray machine may detect foreign objects that pose food safety risks. The different machinery for the process may include a manual casing with manual palletizing and packaging within industry standard options such as drums, pails, tubes, jars, tins, tubs, sachets, pouches, and other innovative options such as metal cans with food grade film and water soluble pods. The nut paste preparation or other paste preparation may be blended, mixed and shaken with water, other liquid, syrup or oil and made into a milk product.

Additional components may be added to modify the nutritional and/or flavor characteristics of the nut base as the nut paste preparation and referred to hereinafter as the nut base and the beverage or other product prepared therefrom.

Examples of the additional components include vanilla (at a concentration of up to about 5 percent by weight); evaporated cane juice; stevia; honey; agave or maple syrup (at a concentration of up to about 15 percent by weight); cacao; cocoa or chocolate syrup (at a concentration of up to about 34 percent by weight); plant, whey, rice or insect protein (at a concentration of up to about 34 percent by weight); coffee beans and soybeans (at a concentration of up to about 80 percent by weight) and flax; poppy; pumpkin; pepitas; hemp; chia; macadamia; toasted sesame or sunflower seeds (at a concentration of up to about 80 percent by weight); oats; millet; amaranth; buckwheat; toasted brown rice and quinoa (at a concentration of up to about 80 percent by weight).

To ensure that no metal was introduced into the nut base during the fabrication process, the nut base may be passed through a metal detector. A person of skill in the art will appreciate that a variety of techniques may be used for detecting the presence of metal in the nut base.

If it is not desired to consume the nut base at a time that is proximate to the time when the nut base is prepared, the nut base can be packaged to facilitate storage and/or transportation of the nut base to a location where the nut base is desired to be used. A person of skill in the art will appreciate that a variety of techniques may be used for packaging the nut base.

When it is desired to consume the beverage or food product, the nut base is mixed with water. In certain embodiments, the mixing is done manually such as using a spoon or stir stick. In other embodiments, the mixing is done such as by placing in an enclosed container and shaking. In still other embodiments, the mixing is done in a powered blender.

The concentration of the nut base used in preparing the product may be selected based upon a variety of factors such as the nature of the product being prepared. When preparing juices smoothies, acai, cereal, coffee, liquors, snacks and baked goods, about 1 ounce to 8 ounces of the nut base are mixed with about 4 cups of water. To modify the nutritional and/or flavor characteristics decrease the water volume or increase the nut base volume.

The nut base may be stored in a relatively compact manner, which minimizes the volume and weight that must be transported until it is desired to consume the nut-based beverage or food product as prepared.

The intrinsic fats and oils in the nut base achieve a unique viscosity that emulsifies the ingredients into a white, foamy, fresh nut milk. The viscosity, color and taste of the product are similar to dairy-based milk and superior to currently available nut-based milk alternatives.

If the same mixing process is used with currently available nut butters or raw almonds in a powered blender, the resulting product would not exhibit comparable quality, taste or texture to the product described herein.

The uniqueness of only requiring a blender or mixer to mix the nut base with water is a significant innovation in the beverage industry and offers a significant advantage as compared to nut-based milk alternatives that are currently on the market.

In other embodiments, the nut base may be provided in a more solid form. In one such solid form, the nut base is compressed into objects such as spheres. Providing the nut base in solid objects may make it easier to transport the nut base until it is desired to prepare a product from the nut base.

Another advantage of using the solid objects is that this configuration may enhance the ability to dispense a desired amount of the nut base into the water depending on the product that is being prepared. The objects may be formed in a variety of sizes and shapes using the concepts of the invention. In certain embodiments, the objects have a size of less than about 1½ inches.

The process used to compress the nut base into the object should not cause the nut base to be too compressed so that the person mixing the nut base with a liquid does not experience challenges in getting the solid objects to dissolve in a reasonable amount of time after being placed in a liquid such as water and not requiring a significant amount of agitation to cause such mixing.

This application is related to copending patent application entitled, “NUT PASTE PREPARATION FOR FOOD AND BEVERAGE,” which is filed on the same date and by the same assignee and inventors, the disclosure which is hereby incorporated by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A method of forming a food and beverage paste preparation, comprising:
delivering a flour derived from nuts, seeds, grain or beans into a shear mixer, wherein the flour has a mean particle size between about 0.002 and 0.012 inches and a moisture content between about 4 to about 6 percent; and
shearing the flour within the shear mixer without adding water for shearing to form a food and beverage paste, wherein the temperature during shearing does not exceed 120 degrees Fahrenheit and the food and beverage paste after shearing has a mean particle size of about 1 to about 40 microns.

2. The method according to claim 1, wherein vacuum is drawn within the shear mixer from beneath the flour during shearing.

3. The method of claim 1, wherein oil is added during shearing when the flour is derived from grains.

4. The method of claim 1, wherein the shear mixer comprises a vacuum bowl cutter containing the flour and rotating at about 20 to 40 rpm.

5. The method of claim 4, wherein the vacuum bowl cutter comprises a knife blade set and drive mechanism supporting the knife blade set that rotates the knife blade set at about 4,500 to 6,500 rpm when shear mixing of the flour.

6. The method of claim 1, wherein the flour is added into the shear mixer at a rate of about 0.65 to 0.99 pounds of flour per liter of shear mixer capacity.

7. The method of claim 1, wherein the flour is cooled during shearing by subjecting the flour to cooled carbon dioxide or nitrogen to maintain the temperature of the flour during shearing to below 100 degrees Fahrenheit.

8. The method of claim 1, wherein the shear mixer comprises a planetary mixer having shear elements operating in a planetary mixing motion at about 4 to about 120 rpm.

9. The method of claim 8, further comprising a rectangular stirrer blade, and spaced disperser blades, wherein the spaced disperser blades rotate at about 1,000 to about 5,000 rpm.

10. The method of claim 1, wherein the temperature during shearing ranges from about 70 to about 110 degrees Fahrenheit.

11. The method of claim 1, wherein the flour is cooled before shearing to below about 45 degrees Fahrenheit into a chilled or frozen state.

12. The method of claim 1, wherein the food and beverage paste after shearing is homogenized within a shear mill having a mull-slot rotor and a multi-port stator that reduce the mean particle size to below about 5 microns.

13. The method of claim 1, wherein the food and beverage paste preparation has a shelf life of about one year without added antioxidants.

14. The method of claim 1, wherein the nuts are selected from the group consisting of almonds, cashews, macadamia nuts, hazelnuts, pistachios, Brazil nuts, coconuts, peanuts, pine nuts, walnuts, pecans, pili nuts, chestnuts, and breadnuts.

15. The method of claim 1, wherein the seeds are selected from the group consisting of sunflower seeds, pumpkin seeds, hemp seeds, sesame seeds, watermelon seeds, cumin seeds, flax seeds, and chia seeds.

16. The method of claim 1, wherein the grains are selected from the group consisting of oats, rice, quinoa, triticale, wheat, barley, spelt, and millet.

17. The method of claim 1, wherein the beans are selected from the group consisting of coffee, cocoa, garbanzo, and kidney.

18. A system of forming a food and beverage paste preparation, comprising:
a cutting mill that receives nuts, seeds, grain or beans and cuts the nuts, seeds, grains or beans into a flour, wherein the flour has a mean particle size between about 0.002 and 0.012 inches and a moisture content between about 4 to about 6 percent; and
a shear mixer that receives and shears the flour without adding water for shearing to form a food and beverage paste, wherein the temperature during shearing does not exceed 120 degrees Fahrenheit and the food and beverage paste after shearing has a mean particle size of about 1 to about 40 microns.

19. The system of claim 18, wherein oil is added during shearing when the flour is derived from grains.

20. The system of claim 18, wherein the shear mixer comprises a vacuum bowl cutter containing the flour and rotating about 20 to 40 rpm.

21. The system of claim 20, wherein the vacuum bowl cutter comprises a first knife blade set and drive mechanism supporting the knife blade set that rotate the knife blade sets at about 4,500 to 6,500 rpm during shear mixing of the flour.

22. The system of claim 18, wherein the shear mixer includes a cooling mechanism that subjects the flour to cooled carbon dioxide or nitrogen to maintain the temperature of the flour during shearing to below 100 degrees Fahrenheit.

23. The system of claim 18, wherein the shear mixer comprises a planetary mixer having shear elements driven in a planetary mixing motion of about 4 to about 120 rpm.

24. The system of claim 23, further comprising a rectangular stirrer blade and spaced disperser blades, wherein the spaced disperser blades rotate at about 1,000 to about 5,000 rpm.

25. The system of claim 18, further comprising a homogenizer mill that receives the food and beverage paste after shearing, said homogenizer mill including a multi-slot rotor and a multi-port stator that reduce the mean particle size to below about 5 microns.
